(19) United States
(12) Patent Application Publication
(10) Pub. No.: US 2001/0015415 A1
(43) Pub. Date: Aug. 23, 2001

(54) Method and apparatus for inspecting disk member

(75) Inventor: Toshihiko Okamoto, Tokyo (JP)

Correspondence Address: DARBY & DARBY P.C., 805 Third Avenue, New York, NY, 10022, US

(73) Assignee: TDK Corporation

(21) Appl. No.: 09/791,020

(22) Filed: Feb. 22, 2001

(30) Foreign Application Priority Data
Feb. 22, 2000 (JP) 2000-050494
Feb. 28, 2000 (JP) 2000-055918

(51) Int. Cl. G01N 21/86; G01N 21/88

(52) U.S. Cl. 250/559.45

(57) ABSTRACT

Disclosed are an inspection method and an inspection apparatus capable of reducing an inspection time while keeping an inspection accuracy about a disk member and, when detecting a plurality of defects, enhancing the inspection accuracy by making a precise judgement about the plurality of defects. An inspection target surface of the disk member is irradiated with light beams, and the light beams reflected from or penetrating the inspection target surface are received by a line camera in which a multiplicity of pixels are arranged in lines towards the outer periphery from the center of the disk member. Information is taken in from the line camera while rotating the disk member, and a normal spot and a defective spot is distinguished based on the information, thereby detecting the defect on the disk member. The multiplicity of pixels of the line camera are divided into a plurality of blocks. The inspection target surface divided corresponding to the divisions of the blocks are scanned in parallel synchronizing with each other through the divided blocks, and pieces of information obtained by this scan are processed in parallel. When detecting a plurality of defects on the inspection target surface of the disk member, a plurality of areas are set with the defects being origins, and it is judged whether the disk member is accepted or unaccepted based on the area containing a maximum number of defects.

### BACKGROUND OF THE INVENTION

1. Field of the Invention

The present invention relates generally to an inspection method of and an inspection apparatus for detecting a defect on an inspection target surface of a disk member such as a disk-shaped recording medium (optical disk) etc, which are capable of reducing an inspection time while keeping an inspection accuracy (a resolution, a detection capability) and, when detecting a plurality of defects, making a precise judgement about the plurality of defects.

2. Related Background Art

What is known as an inspection apparatus for detecting a defect on the surface of the disk-shaped recording medium such as an optical disk etc, is an apparatus having a configuration shown in FIG. 5. In the conventional inspection apparatus shown in FIG. 5, a disk-shaped recording medium 13 is irradiated with light beams from a light source 10, and a line camera 30 including pixels (picture elements) arranged in lines receives the light beams penetrating the medium 13. A one-round scan is executed in a way that the disk-shaped recording medium 13 is rotated by a motor 31 controlled by a motor control unit 32. Video output signals of the line camera 30 are subjected to image processing with an image processing device 33. A CPU (central processing unit) analyzes a defect based on the processing information, and a result of whether the detect is critical or not is displayed on a CRT (cathode ray tube; image display device) 35 or outputted to a sequencer 36. FIG. 6 shows an example of a relationship between pixels (of which the number is 2048) and a received light quantity, which are obtained by a 1-line scan in the radial direction.

FIG. 7 is a diagram schematically showing an image memory obtained by one single line camera in which pixels are arranged in lines in the conventional inspection apparatus in FIG. 5. The axis of abscissas represents the pixel No. of the pixels on the line camera, which are arranged in the radial directions towards the outer periphery from the center of the disk-shaped recording medium, wherein the pixel No.1 indicates an innermost periphery, and the pixel No.2048 indicates an outermost periphery. The axis of ordinates represents a scan count when the disk makes one rotation, wherein the first scan indicates a start of rotation of the disk, and the 12000th indicates an end of rotation of the disk (after the rotation through 360 degrees). As obvious from FIG. 7, a resolution in the radial direction of the disk-shaped recording medium is determined by the number of pixels arranged on the line camera. A resolution in the circumferential direction of the disk-shaped recording medium is determined by the scan count during one rotation of the disk. Further, a 1-scan time is determined by a time for taking in 1-pixel information of the line camera and by an image processing device attached to the line camera. An inspection time is therefore determined by the scan count during one rotation of the disk-shaped recording medium.

According to the conventional inspection apparatus described above, it is required that the scan count be fixed in order to keep the resolution in the circumferential direction of the disk-shaped recording medium. Hence, there is no alternative but a method of shortening the time for taking in the 1-pixel information in order to reduce the inspection time in a way that keeps the resolution in the circumferential direction of the disk-shaped recording medium. If the time for taking in the 1-pixel information is decreased, however, a received light quantity per pixel decreases, resulting in such a problem that the detection capability declines.

The defect is detected based on a difference between the received light quantities of the transmitted light beams. In the case of the reflected light beams, however, the defect is detected in the same way. A judgement of how much the defect is critical is made by setting a threshold value for detecting a size of the defect and comparing the defect signal with this threshold value. Further, as for an inspection method based on the transmitted light beams, for example, Japanese Patent Application Laid-Open Publication No. 9-190628 discloses amethod of obtaining a size of the defect and a defect ratio. As for an inspection method based on the reflected light beams, for example, Japanese Patent Application Laid-Open Publication No. 10-143801 discloses a defect inspection method.

By the way, there are defects having a variety of sizes on the disk. A large defect, even though single, leads to an error when recorded or reproduced. By contrast, one small defect does not cause an error, however, if several small defects exist (densely) within a certain area, this causes the error. Thus, a conventional judging method in the case of detecting a plurality of defects within a fixed area will be explained referring to FIGS. 13A and 13B.

As shown in FIG. 13A, a disk D is divided by, e.g., 8 in the circumferential direction (at every 45 degrees), and the number of defects in each inspection area is counted. If two or less defects exist in that area, the disk may be judged to be accepted. If thee or more defects exist, the disk may be judged to be unaccepted. A case is considered, wherein this judging criterion is provided. FIG. 13A shows a position of an inspection start point S1. When three defects 21, 22, 23 are detected in an area 50 defined in a scan direction R through 45 degrees counterclockwise from the inspection start point S1, the disk D is judged to be defective. If the inspection area changes to an area 50′ defined in the scan direction R through 45 degrees clockwise from an inspection start point S2 shifted clockwise (in the opposite direction to the scan direction R) in contrast with FIG. 13A as indicated by a solid line, the area 50′ contains only one defect as compared with the area 50 indicted by the broken line in FIG. 13B, it follows that the disk D is judged to be acceptable.

As explained above, according to the conventional inspection methods, there might arise a problem that the disk that should originally be judged to be defective is misjudged to be acceptable.

### SUMMARY OF THE INVENTION

It is a first object of the present invention to provide an inspection method and an inspection apparatus capable of reducing an inspection time while keeping an inspection accuracy (a resolution, a detection capability) with respect to a disk member such as a disk-shaped recording medium or the like.

It is a second object of the present invention to provide an inspection method and an inspection apparatus capable of, when detecting a plurality of defects on the disk member such as the disk-shaped recording medium or the like, making a precise judgement about the plurality of defects, and enhancing an inspection accuracy.

It is a third object of the present invention to provide an inspection method and an inspection apparatus capable of reducing an inspection time while keeping an inspection accuracy with respect to the disk member such as the disk-shaped recording medium or the like and, when detecting the plurality of defects, making a precise judgement about the plurality of defects as well as of enhancing an inspection accuracy.

A first inspection method of inspecting a disk member according to the present invention includes a step of irradiating an inspection target surface of the disk member with light beams, a step of receiving the light beams reflected from or penetrating the inspection target surface by a light receiving unit disposed towards an outer periphery from the center of the disk member, a step of obtaining information by the light receiving unit moving relatively to the disk member, a step of inspecting the disk member on the basis of the information, and a step of distinguishing between a normal spot and a defective spot, wherein the light receiving unit is divided into a plurality of blocks, and respective pieces of information obtained from the divided blocks are processed in parallel.

According to the first inspection method, the information obtained from the plurality of blocks into which the light receiving unit is divided is processed in parallel, and hence the inspection target surface is divided corresponding to the divisions of the light receiving unit, whereby the divided inspection target surfaces can be simultaneously inspected. Therefore, an inspection time can be reduced while keeping an inspection accuracy such as a resolution and a detection capability without changing a scan count.

In this case, the light receiving unit maybe configured by an aggregation of a plurality of pixels arranged in lines, the aggregation of the plurality of pixels may be divided into two or more blocks, and the normal spot may be distinguished from the defective spot on the basis of the information subjected to a linking process after being obtained in parallel per block.

Further, if target signals are detected at a boundary between the proceeding block and the next block among the divided blocks, a linking process of linking these signals may be executed. With this processing, it is feasible to accurately distinguish between the defect signals detected in the vicinity of the boundary between the divided inspection target surfaces and thus make a precise judgement.

Moreover, the light beams may be visible light beams or near infrared-rays, a difference between received light quantities of the reflected light beams or transmitted light beams in the light receiving unit, may be set as an individual piece of information obtained from the divided block, these pieces of information may be set as image information and processed in parallel by an image processing device and thereafter processed in linkage by a central processing unit, and it may be judged whether the disk member is accepted or unaccepted from a threshold value predetermined based on the above distinction, and a result of this judgement is displayed on the display device. The respective pieces of information of the divided blocks are, after being processed in parallel by the image processing device, integrated by a central processing unit and processed as information on one single disk member. Then, a judgement is made, and a result of this judgement is displayed on the display device.

A first inspection apparatus for inspecting a disk member according to the present invention includes a light source for irradiating an inspection target surface of the disk member with light beams, a light receiving unit, for receiving the light beams reflected from or penetrating the inspection target surface, disposed towards an outer periphery from the center of the disk member, a moving unit for moving the disk member relatively to the light receiving unit, and a distinguishing unit for inspecting the disk member on the basis of information obtained by the light receiving unit moving relatively to the disk member, and distinguishing between a normal spot and a defective spot, wherein the distinguishing unit divides the light receiving unit into a plurality of blocks, and processes respective pieces of information obtained from the divided blocks in parallel.

The first inspection apparatus is capable of executing the first inspection method described above and simultaneously inspection the divided inspection target surfaces without changing the scan count, and hence the inspection time can be reduced while keeping the inspection accuracy such as the resolution and the inspection capability.

A second inspection method of inspecting a disk member according to the present invention includes a step of irradiating an inspection target surface of the disk member with light beams, a step of receiving the light beams reflected from or penetrating the inspection target surface by light receiving unit disposed towards an outer periphery from the center of the disk member, a step of obtaining information by the light receiving unit moving relatively to the disk member, a step of inspecting the disk member on the basis of the information, and a step of distinguishing between a normal spot and a defective spot, wherein when counting the number of defects existing in areas into which the inspection target surface is arbitrarily divided, the areas are set a fresh with the defects being origins for every defect.

According to the second inspection method, when judging whether the defects are critical or not from the number of the plurality of defects detected in the fixed area, these areas are set with the respective defects being the origins, and it is can be judged whether the disk member is accepted or unaccepted based on the area containing the maximum number of defects. The judgement is therefore precise, and the inspection accuracy is enhanced.

In this case, the arbitrarily divided areas may be segment areas into which the inspection target surface is segmented at a predetermined angle in the circumferential direction. Further, the arbitrarily divided areas may be areas into which the inspection target surface is divided at a predetermined distance in the radial direction. Note that the arbitrarily divided areas may also be divided in the circumferential direction and in the radial direction.

The light receiving unit may be configured by an aggregation of a plurality of pixels arranged in lines, the light beams may be visible light beams or near infrared-rays, a normal spot and a defective spot may be distinguished from each other based on a difference between received light quantities of the reflected light beams or transmitted light beams in the light receiving unit, and it maybe judged whether the disk member is accepted or unaccepted from a threshold value predetermined based on the above distinction.

A second inspection apparatus for inspecting a disk member according to the present invention includes a light source for irradiating an inspection target surface of the disk member with light beams, a light receiving unit, for receiving the light beams reflected from or penetrating the inspection target surface, disposed towards an outer periphery from the center of the disk member, a moving unit for moving the disk member relatively to the light receiving unit, a distinguishing unit for inspecting the disk member on the basis of information obtained by the light receiving unit moving relatively to the disk member, and distinguishing between a normal spot and a defective spot, a count unit for counting the number of defects existing in areas into which the inspection target surface is arbitrarily divided, and a setting unit for setting the areas afresh with the defects being origins for every defect.

The second inspection apparatus is capable of executing the second inspection method described above and, when judging whether or not the plurality of defects detected are critical based on the number of defects contained in the fixed areas, the areas are set with the respective defects being the origins, and it is possible to judge whether or not the disk member is accepted or unaccepted based on the area containing the maximum number of defects. Hence, the judgement thereof becomes accurate, and the inspection accuracy is enhanced.

A third inspection apparatus for inspecting a disk member according to the present invention includes a light source for irradiating an inspection target surface of the disk member with light beams, a light receiving unit, for receiving the light beams reflected from or penetrating the inspection target surface, disposed towards an outer periphery from the center of the disk member, a moving unit for moving the disk member relatively to the light receiving unit, a distinguishing unit for inspecting the disk member on the basis of information obtained by the light receiving unit moving relatively to the disk member, and distinguishing between a normal spot and a defective spot, the distinguishing unit dividing the light receiving unit into a plurality of blocks and processing in parallel pieces of information obtained from the divided blocks, a count unit for counting the number of defects existing in areas into which the inspection target surface is arbitrarily divided, and a setting unit for setting the areas afresh with the defects being origins for every defect.

According to the third inspection apparatus, the pieces of information obtained from the plurality of blocks into which the light receiving unit is divided, are processed in parallel, so that the inspection target surface is divided corresponding to the divisions of the light receiving unit. The divided inspection target surfaces can be simultaneously inspected. It is also feasible to reduce the inspection time while keeping the inspection accuracy such as the resolution and the inspection capability without changing the scan count. When judging whether the plurality of defects are critical or not based on the number of defects in the fixed areas, the areas are set with the defects being the origins, and it can be judged whether the disk member is accepted or unaccepted based on the area containing the maximum number of defects. The judgement thereof becomes precise, and the inspection accuracy is enhanced.

A third inspection method of inspecting a disk member according to the present invention includes a step of irradiating an inspection target surface of the disk member with light beams, a step of receiving the light beams reflected from or penetrating the inspection target surface by light receiving unit disposed towards an outer periphery from the center of the disk member, a step of obtaining information by the light receiving unit moving relatively to the disk member, a step of dividing the light receiving unit into a plurality of blocks, processing in parallel respective pieces of information obtained from the divided blocks, and linking these pieces of information between the divided blocks, a step of distinguishing between a normal spot and a defective spot on the basis of the pieces of information linked, a step of arbitrarily dividing the inspection target surface on the disk member, a step of counting the number of defects existing in areas into which the inspection target surface is arbitrarily divided, a step of setting the areas afresh with the defects being origins for every defect, and a step of judging whether or not the defects are critical in the areas set afresh.

The third inspection method can be executed by the third inspection apparatus described above. The inspection time can be reduced while keeping the inspection accuracy with respect to the disk member. Besides, when detecting the plurality of defects, the judgement about the plurality of defects can be precisely made, and the inspection accuracy can be enhanced.

In this case, the normal spot and the defective spot are distinguished from each other, and the defective spot is judged from a predetermined threshold. Thereafter, the number of the defects existing in the divided areas, which exceeds the threshold value, is counted, and the areas are set afresh for every defect, wherein the defects exceeding the threshold value serve as the origins. Then, it may be finally judged whether the defects exceeding the threshold value in the newly set area are critical or not.

### BRIEF DESCRIPTION OF THE DRAWINGS

FIG. 1 is a diagram schematically showing a configuration of an apparatus for inspecting a disk member in a first embodiment;

FIG. 2A is a graph showing an example of a relationship between a received light quantity and pixels (picture elements) in an inner-peripheral-side block of a line camera 14, which are obtained by a scan for one line in the radial direction by the inspection apparatus in FIG. 1; FIG. 2B is a graph showing an example of a relationship between the received light quantity and the pixels in an outer-peripheral-side block;

FIG. 3A is a diagram schematically showing an image memory obtained by the line camera as a light receiving unit with the pixels (picture elements) arranged in lines in the inner-peripheral-side block of the line camera in the inspection apparatus in FIG. 1; FIG. 3B is a diagram schematically showing an image memory obtained in the outer-peripheral-side block;

FIG. 4A is a diagram schematically showing an image memory obtained in the inner-peripheral-side block for explaining how defects are judged if the defects occur at a boundary between the inner-peripheral-side block and the outer-peripheral-side block in the line camera by the inspection apparatus in FIG. 1; FIG. 4B is a diagram schematically showing an image memory obtained in the outer-peripheral-side block for the same purpose;

FIG. 5 is a diagram schematically showing a configuration of a conventional inspection apparatus for inspecting a disk-shaped recording medium;

FIG. 6 is a gram showing a relationship between the pixels (picture elements) and a received light quantity of the line camera, which are obtained by the 1-line scan in the radial direction by the conventional inspection apparatus;

FIG. 7 is a diagram schematically showing an image memory obtained by the line camera in which the pixels (picture elements) are arranged in lines in the conventional inspection apparatus;

FIG. 8 is a diagram schematically showing a configuration of an inspection apparatus for inspecting a disk member in a second embodiment;

FIG. 9 is a gram showing a relationship between the pixels (picture elements) and a received light quantity of the line camera, which are obtained by the 1-line scan in the radial direction by the inspection apparatus in FIG. 8;

FIG. 10 is a diagram schematically showing an image memory obtained by the line camera as a light receiving unit in which the pixels (picture elements) are arranged in lines in the inspection apparatus in FIG. 8;

FIG. 11 is a plan view showing an inspection target surface of the disk member for explaining an inspection method in the second embodiment;

FIG. 12 is a plan view showing an inspection target surface of the disk member for explaining a modified example of the inspection method in the second embodiment;

FIG. 13A is a plan view showing an inspection target surface of the disk member for explaining a conventional inspection method; FIG. 13B is a plan view showing a problem inherent in the prior art; and

FIG. 14 is a diagram schematically showing a configuration of an inspection apparatus for inspecting a disk member in a third embodiment.

### DESCRIPTION OF THE PREFEREED EMBODIMENTS

<First Embodiment>

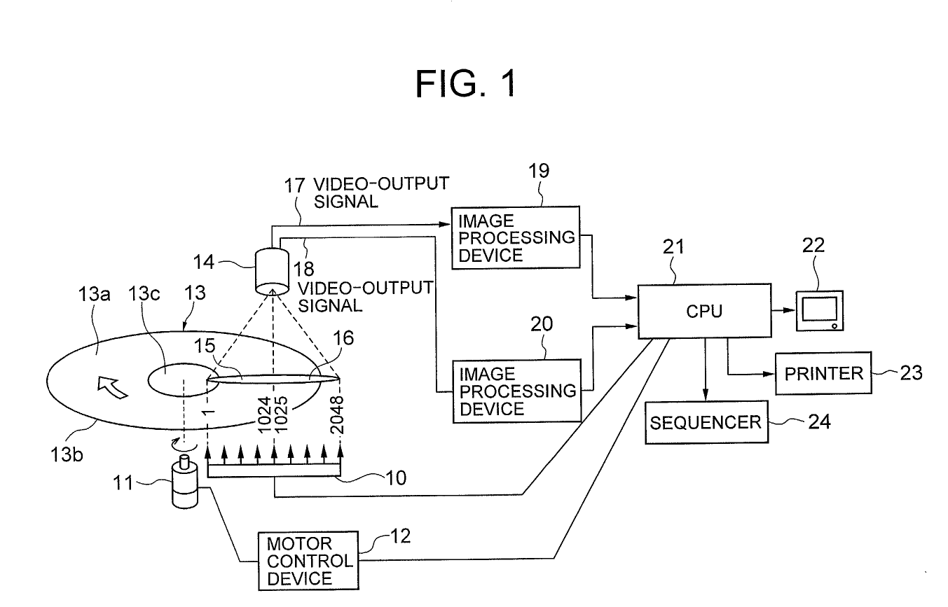

FIG. 1 is a diagram schematically showing an apparatus for inspecting a disk member in a first embodiment. The inspection apparatus shown in FIG. 1 includes a line camera 14 serving as a light receiving unit constructed of a one-dimensional CCD or the like structured in a way that arranges a multiplicity of pixels (picture elements) in lines, and image processing devices 19, 20 for taking in video output signals outputted from this line camera 14, and executing image processing such as shaping a waveform by an analog or digital filtering process, and so on. The inspection apparatus further includes a central processing unit (CPU) 21 for judging based on the image processing signal with the waveform shaped whether there exists a defect or not, and judging whether this defect is critical or not by a comparison with a predetermined threshold value and executing a binary process. The inspection apparatus also includes a display device 22 for displaying a result of judgement on a display, a printer 23 for printing the result of judgement on a sheet of recording paper, and a sequencer 24 for controlling a sequence of the inspection apparatus on the basis of the result of judgement.

Further, the inspection apparatus has a light source 10 constructed of a halogen lamp etc for irradiating an under surface 13b of a disk member 13 defined as an inspection target with light beams, a motor 11 for rotating the disk member 13 for its inspection, and a motor control unit 12 for controlling the motor 11 on the basis of an indication given from the CPU 21. The disk member 13 is defined as a disk-shaped recording medium formed with a light transmissive substrate and a recording layer.

The line camera 14 is provided above a surface 13a so as to receive the beams that fall upon and penetrate the under surface 13b of the disk member 13 from the light source 10. The line camera 14 has a configuration that a multiplicity of pixels are arranged in lines facing to an outer periphery from a central hole 13c of the disk member 13. The multiplicity of pixels (e.g., a total number of pixels is 2048) of the line camera 14 serving as a light receiving device are segmented into two blocks on inner and outer peripheral sides. As shown in FIG. 1, the inspection target surface, i.e., the surface 13a of the disk member 13 is formed with an inner-peripheral-side imaging area 15 and an outer-peripheral-side imaging area 16 that are minutely segmented long extending in the radial directions, corresponding to the two segmented blocks. The imaging area 15 embraces the pixels with No.1 to No.1024, while the imaging area 16 embraces the pixels with No.1025 to No.2048.

An operation of the inspection apparatus shown in FIG. 1 will be explained. The motor control unit 12 rotates the motor 11 on the basis of an indication given from the CPU 21, thereby rotating the disk member 13 at a fixed rotating speed. On the other hand, the light source 10 is lit up to irradiate the disk member 13 form the under surface 13b with the light beams. Next, the line camera 14 scans over the imaging areas 15 and 16 on the surface 13a of the disk member 13 each taking synchronism. The light beams penetrating the imaging areas 15, 16 on the disk member 13 are imaged in the respective blocks of the line camera 14. Video output signals 17 (corresponding to the pixels with No.1 to No.1024) of the inner-peripheral-side imaging area 15 and video output signals 18 (corresponding to the pixels with No.1025 to No.2048) of the outer-peripheral-side imaging area 16, are outputted in parallel corresponding to quantities of the light beams received from the respective blocks of the line camera 14, in which the imaging has took place, and are inputted to the image processing devices 19, 20, respectively. Those video output signals 17, 18 are subjected the image processing such as shaping the waveforms in parallel and so on, which progress simultaneously. Then, the image processing signals from the image processing devices 19, 20 are processed linked based on a scan count in the CPU (central processing unit) 21, and thus integrated. With this processing, pieces of information obtained from the blocks (the imaging areas 15, 16) can be integrated as a set of information about the one single disk member 13.

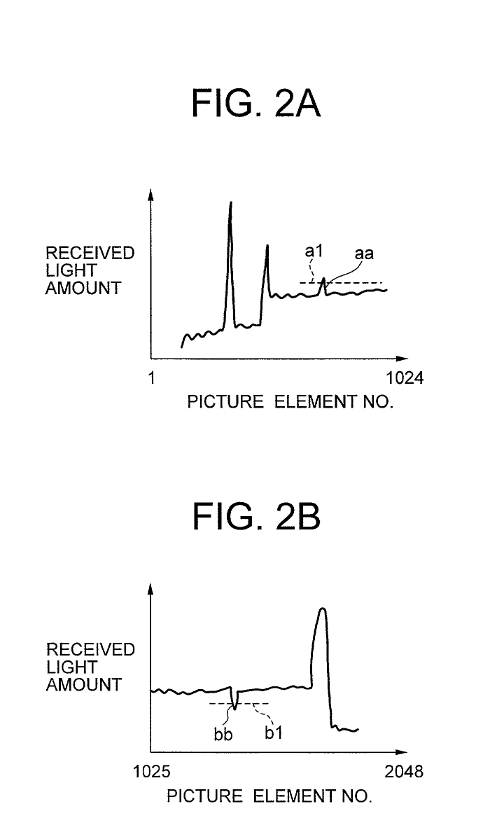

FIG. 2A is a graph showing an example of a relationship between a received light quantity and the pixels (given No. 1 to N.1024) in the inner-peripheral-side block of the line camera 14, which are obtained by a scan for one line in the radial direction by the inspection apparatus in FIG. 1. FIG. 2B is a graph showing an example of a relationship between the received light quantity and the pixels (given No. 1025 to N.2048) in the outer-peripheral-side block.

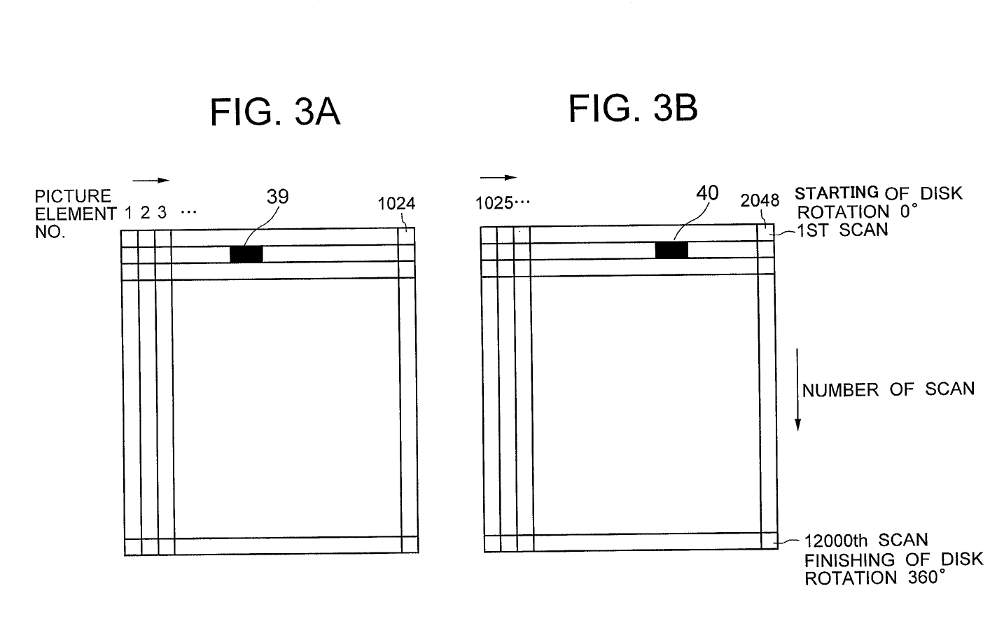

FIG. 3A is a diagram schematically showing an image memory obtained by the line camera with respect to the pixels (with No. 1 to No.1024) in the inner-peripheral-side block of the line camera in the inspection apparatus in FIG. 1. FIG. 3B is a diagram schematically showing an image memory obtained with respect to the pixels (with No. 1025 to No.2048) in the outer-peripheral-side block. Referring to FIGS. 3A and 3B, the axis of abscissas represents the pixel No., while the axis of ordinates represents a scan count. The image memory in FIG. 3A is obtained by processing the video output signals 17 by the image processing device 19. The image memory in FIG. 3B is obtained by processing the video output signals 18 by the image processing device 20.

For example, it is assumed that a defect such as a pinhole etc occurs in the disk member 13 with the result that the received light quantity of the line camera 14 changes, there is caused a difference in the received light quantity from those of the pixels (with no defect) disposed posterior and anterior to the pinhole, and a plus peak aa as shown in FIG. 2A occurs as a result of shaping the waveforms by the image processing devices 19, 20. In this case, a value of this peak aa is compared with a preset threshold value a1, and, if equal to a1 or larger, the CPU 21 judges that this is a defect signal. Further, a position of the defect can be pinpointed as a defect signal 39 on the image memory as shown in FIG. 3A. Similarly, if a minus peak bb as shown in FIG. 2B occurs, a value of this peak bb is compared with a preset threshold value b1, and, if equal to b1 or smaller, the CPU 21 judges that this is a defect signal. Further, a position of the defect can be pinpointed as a defect signal 40 on the image memory as shown in FIG. 3b. Thus, the inspection target surface of the surface 13a is inspected, thereby making it feasible to distinguish between a normal spot and the defective spot. Then, if the defect signal judged to be the defect exceeds the predetermined threshold value, this defect may be judged to be critical (unaccepted). The predetermined threshold values may be the threshold values a1 and b1 in FIGS. 2A and 2B and may also be set otherwise. Moreover, the position of the defect detected can be pinpointed on the actual inspection target surface from the relationship between the pixel No. and the scan count as shown in FIGS. 3A and 3B.

Next, the pieces of information on the defect signals 39, 40 described above are displayed on the display device 22 and can be printed by the printer 23. Further, the judgement as to whether the disk member inspected is defective or not can be outputted to the sequencer 24. If the result of the judgement is critical (unaccepted), there may be executed a process such as removing the unaccepted disk member out of the inspection process.

In the inspection process described above, supposing that a time for taking in the information on one pixel of the line camera 14 serving as the light receiving unit is set to the same as in the prior art, a one-scan time is half the time in the prior art because of the respective blocks being scanned simultaneously in parallel as shown in FIGS. 3A and 3B and of the output signals 17, 18 being processed simultaneously by the image processing devices 19, 20. Herein, if the whole peripheries on the disk member are scanned 12000 times by the line camera having 20 MHz and 2048 pixels, the prior art inspection apparatus takes 1.23 sec as a time for taking in one-pixel information, and by contrast the inspection apparatus in the first embodiment takes a time of as short as 0.61 sec. The inspection time can be thus decreased by half. Besides, the respective imaging areas can be simultaneously inspected without changing the scan count, and hence the inspection time can be reduced while keeping the inspection accuracies such as a resolution, a detection capability etc. This enables a production efficiency of the whole products to be enhanced in a way that keeps a quality of the product.

As discussed above, the inspection target surface is segmented into the imaging areas, these imaging areas are simultaneously scanned, and the signals obtained therefrom are simultaneously subjected to the image processing in parallel by the separate image processing devices, whereby the inspection time can be reduced. In accordance with the first embodiment, the total number of pixels of the line camera is divided by 2, and the inspection time can be reduced by half. The present invention is not, however, limited to this division mode. The total number of pixels maybe divided by 3 or greater, whereby the inspection time can be further reduced and the inspection can be also further speeded up. Moreover, the inspection apparatus in the first embodiment detects the surface defects such as the pinhole, a damage, wetting, a foreign matter etc, and is capable of detecting internal defects.

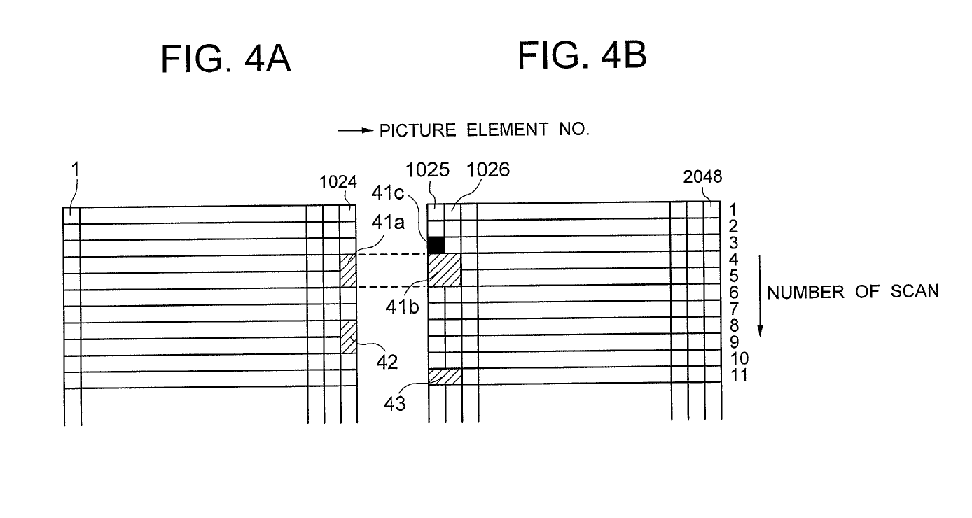

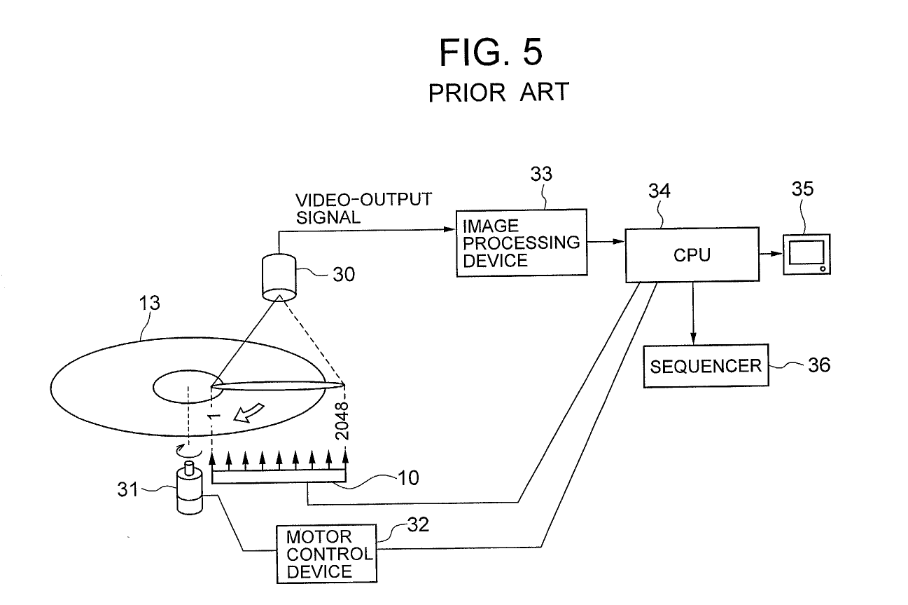

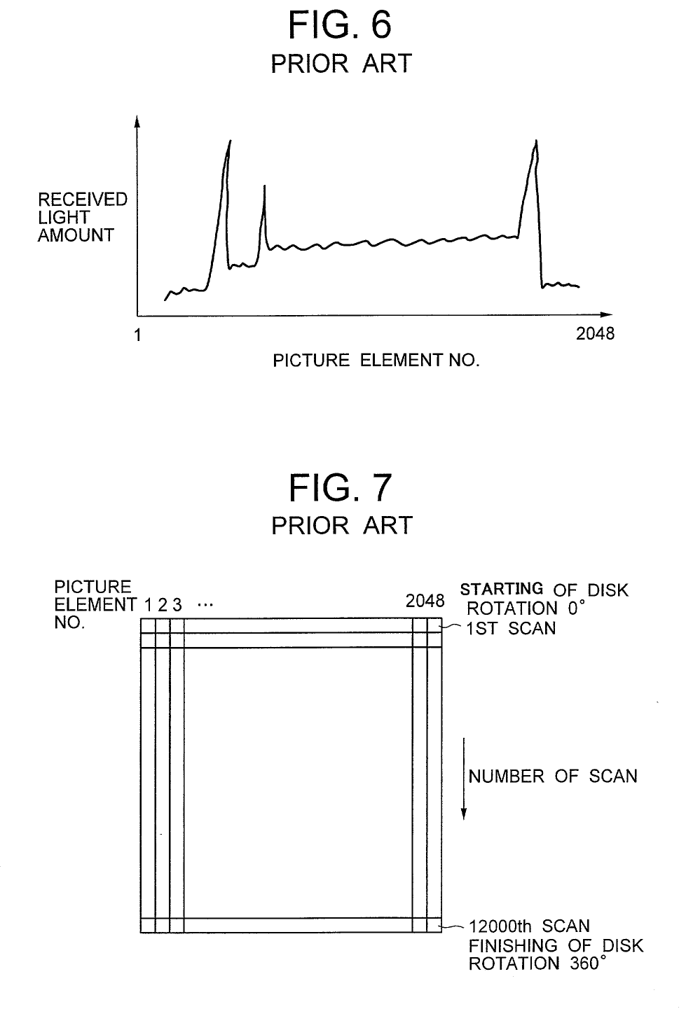

Next, if the defect signal is detected in the vicinity of a boundary at which to divide the (number of) pixels of the light receiving unit in the inspection apparatus in FIG. 1, a judging method thereof will be explained referring to FIGS. 4A and 4B. For example, as shown in FIG. 4A, a defect signal 41a occurs at the fourth and fifth scans over the pixel with No.1024 on the image memory of the inner-peripheral-side block. Then, as shown in FIG. 4B, and a defect signal 41b occurs at the fourth and fifth scans over the pixels with Nos.1025 and 1026 on the image memory of the outer-peripheral-side block. In this case, the CPU 21 executes a process of linking the defect signals 41a, 41b on the basis of the scan counts. The defect signals 41a, 41b are detected at the same scan counts, and hence the CPU 21 judges that these signals are the continuous defect signals. Thus, if it is judged that the defect signals detected at the boundary of the two blocks are integral, it is judged based on an aggregation size of the defects whether the detect is critical or not. Further, for instance, if a defect signal 41c occurs at the third scan over the pixel of No.1025, the defect signals 41a, 41b, 41c are judged to be one continuous defect signal.

Moreover, referring to FIG. 4A, if a defect signal 42 occurs at the eighth and ninth scans over the pixel of No.1024. On the other hand, referring to FIG. 4B, a defect signal 43 occurs at the eleventh scan over the pixels of Nos.1025 and 1026. In this case, the defects signals 42 and 43 do not occur at the same scan count and are therefore judged to be independent defect signals.

When the defect signals are detected at the boundary of the blocks segmented as described above, the linking process is executed based on the scan counts, thereby making it possible to judge whether the defect signals may be defined as the same continuous defect signal.

The present invention has been discussed so far by way of the first embodiment but is not limited to this. The present invention can be modified in a variety of forms within the scope of the technical concept of the present invention. For example, the disk member is irradiated with the light beams from the light source, and the line camera of the light receiving device may receive the light beams reflected from the disk member, wherein the same effect as in the case of the transmitted light is obtained. Further, a light source capable of emitting near infrared-rays having a wavelength on the order of 800 to 1100 nm, may also be used.

Further, the inspection target disk member is categorized as an optical disk that includes, specifically, a CD, a CD-R, a CD-RW, an MD, a DVD etc. The disk member may be a light transmissive substrate for those recording mediums but is not limited to this type of substrate. The disk member may be, as a matter of course, those for other applications.

According to the inspection method and the inspection apparatus in the first embodiment discussed above, the inspection time can be reduced without any decline of the inspection accuracies (the resolution, the detection capability), and it is feasible to keep the quality of the disk member and enhance the productivity thereof.

<Second Embodiment>

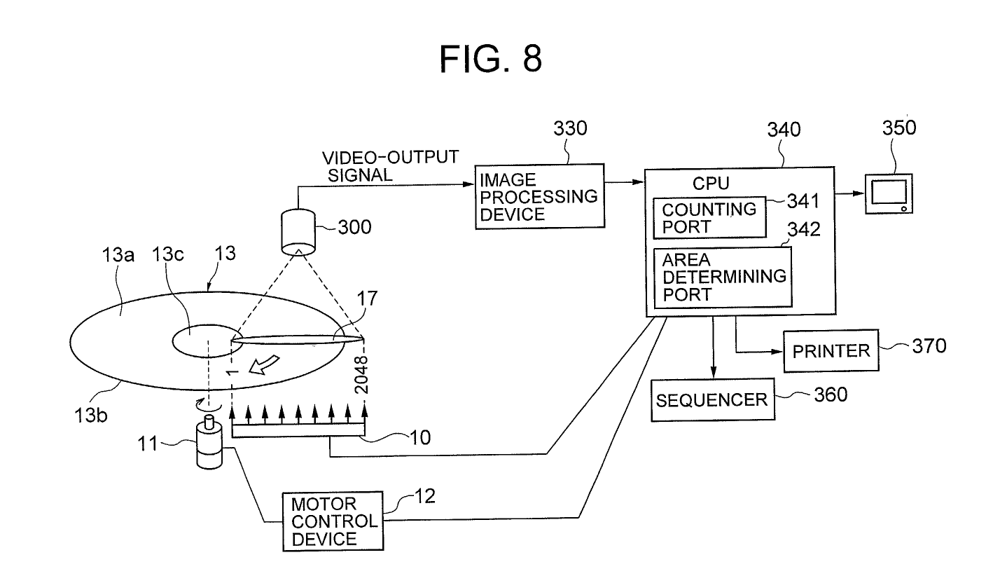

FIG. 8 is a diagram schematically showing an inspection apparatus for inspecting the disk member, which is capable of executing an inspection method in a second embodiment. The inspection apparatus shown in FIG. 8 includes a line camera 300 serving as a light receiving unit constructed of a one-dimensional CCD etc structured in a way that arranges a multiplicity of pixels in lines, and an image processing device 330 for taking in video output signals outputted from this line camera 300, and executing image processing such as shaping a waveform by an analog or digital filtering process, and so on. The inspection apparatus further includes a central processing unit (CPU) 340 for judging based on the image processing signal with the waveform shaped whether there exists a defect or not, and judging whether this defect is critical or not by a comparison with a predetermined threshold value and executing a binary process. The inspection apparatus also includes a display device 350 for displaying a result of judgement on a display, a printer 370 for printing the result of judgement on a sheet of recording paper, and a sequencer 360 for controlling a sequence of the inspection apparatus on the basis of the result of judgement.

Further, the inspection apparatus has the light source 10 constructed of the halogen lamp etc for irradiating then under surface 13b of the disk member 13 defined as the inspection target with light beams, the motor 11 for rotating the disk member 13 for its inspection, and the motor control circuit 12 for controlling the motor 11 on the basis of an indication given from the CPU 340. The disk member 13 is defined as a disk-shaped recording medium formed with a light transmissive substrate and a recording layer.

The line camera 300 is provided above the surface 13a so as to receive the beams that fall upon and penetrate the under surface 13b of the disk member 13 from the light source 10. The line camera 300 has a configuration that a multiplicity of pixels are arranged in lines facing to an outer periphery from the central hole 13c of the disk member 13.

The CPU 340 includes a counter 341 for counting the number of defects when a plurality of defects are detected from the disk member 13, and a region setting unit 342 for setting a region with each defect being an origin for every defect. Herein, the region connotes one of a plurality of regions into which the inspection target surface on the disk member 13 is segmented.

An operation of the inspection apparatus shown in FIG. 8 will be explained. The motor control device 12 rotates the motor 11 on the basis of an indication given from the CPU 340, thereby rotating the disk member 13 at a fixed rotating speed. On the other hand, the light source 10 is lit up to irradiate the disk member 13 form the under surface 13b with the light beams. Next, the line camera 300 scans over the surface 13a of a disk member D, whereby the light beams penetrating the disk member 13 are imaged in the imaging area 17 on the surface 13a. Video output signals are outputted corresponding to a quantity of the light beams received from line camera 300 and inputted to the image processing device 330, wherein the image processing is executed. The processing signal given from the image processing device 330 is subjected t an arithmetic process in the CPU (central processing unit) 340. Then, it is judged whether the signal indicates a defect or not and also whether the inspection target disk member is accepted or unaccepted.

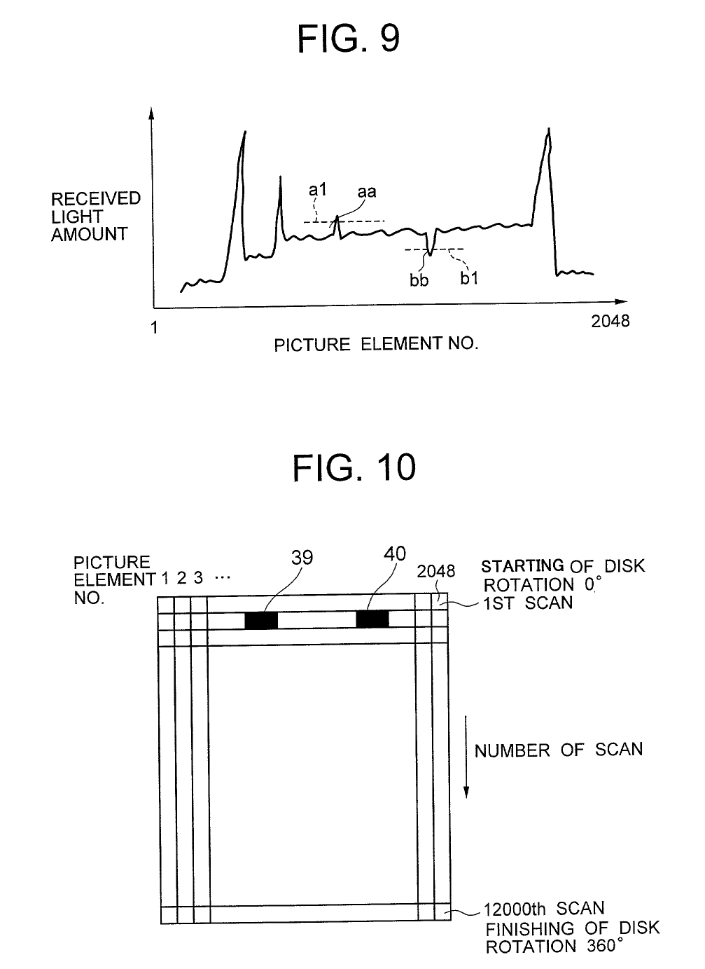

As discussed above, in the inspection apparatus in FIG. 8, the one-round scan is carried out while rotating the disk member 13, and the video output signals corresponding to the received light quantity are outputted from the line camera 300 in which the multiplicity of pixels are arranged in lines. Then, FIG. 9 shows a relationship between the received light quantity and the pixels (of which the number is 2048) of the line camera, which obtained by the one-line scan effected in the radial direction.

FIG. 10 is a diagram schematically showing an image memory that has taken in images from the imaging area 17 on the disk member 300 by the line camera 300 on which the pixels are arranged in lines in the inspection apparatus shown in FIG. 8. The axis of abscissas represents the pixel No. of the pixels on the line camera 300, which are arranged in the radial directions towards the outer periphery from the center of the disk member, wherein the pixel No.1 indicates an innermost periphery, and the pixel No.2048 indicates an outermost periphery. The axis of ordinates represents a scan count when the disk makes one rotation, wherein the first scan indicates a start of rotation of the disk, and the 12000th indicates an end of rotation of the disk (after the rotation through 360 degrees). The image memory shown in FIG. 10 is obtained by processing the video output signals in the image processing device 330, and is stored with results of the inspections of the whole inspection target surface on the disk member 13.

Referring to FIG. 9, for example, it is assumed that a defect such as a pinhole etc occurs in the disk member 13 with the result that the received light quantity of the line camera 300 changes, there is caused a difference in the received light quantity from those of the pixels (with no defect) disposed posterior and anterior to the pinhole, and a plus peak aa as shown in FIG. 9 occurs. In this case, a value of this peak aa is compared with a preset threshold value a1, and, if equal to a1 or larger, the CPU 340 judges that this is a defect. Further, a position of the defect can be pinpointed as a defect 39 on the image memory as shown in FIG. 10. Similarly, if a minus peak bb occurs, a value of this peak bb is compared with a preset threshold value b1, and, if equal to b1 or smaller, the CPU 340 judges that this is a defect. Further, a position of the defect can be pinpointed as a defect 40 on the image memory as shown in FIG. 10. Thus, the inspection target surface of the surface 13a on the disk member 13 is inspected, and the defect is detected from the difference between the received light quantities, thereby making it feasible to distinguish between a normal spot and the defective spot.

Note that if threshold values larger than the threshold values a1, b1 described above are set, and if a (plus or minus) peak of the received light quantity exceeds these larger threshold values, the disk member is judged to be defective solely from the defect detected. Accordingly, supposing that the peaks aa, bb (the defects 39, 40) in FIG. 9 singly exist, the disk member is judged to be accepted. If a plurality of defects described above are detected, the judgement is made based on a judgement criterion that will hereinafter be explained.

As described above, according to the inspection apparatus in FIG. 8, the one-round scan is executed while rotting the disk member 13, and the video output signals from the line camera 300 are subjected to the image processing by the image processing device 330. The CPU (central processing unit) 340, based on this piece of processing information, analyzes the detect, and a result of whether the defect is accepted or unaccepted is displayed on the CRT (corresponding to the image display device) 350. In this case, the position of the detected defect can be pinpointed on the actual inspection target surface from the relationship between the pixel No. of the pixels of the line camera 300 and the scan count as shown in FIG. 10.

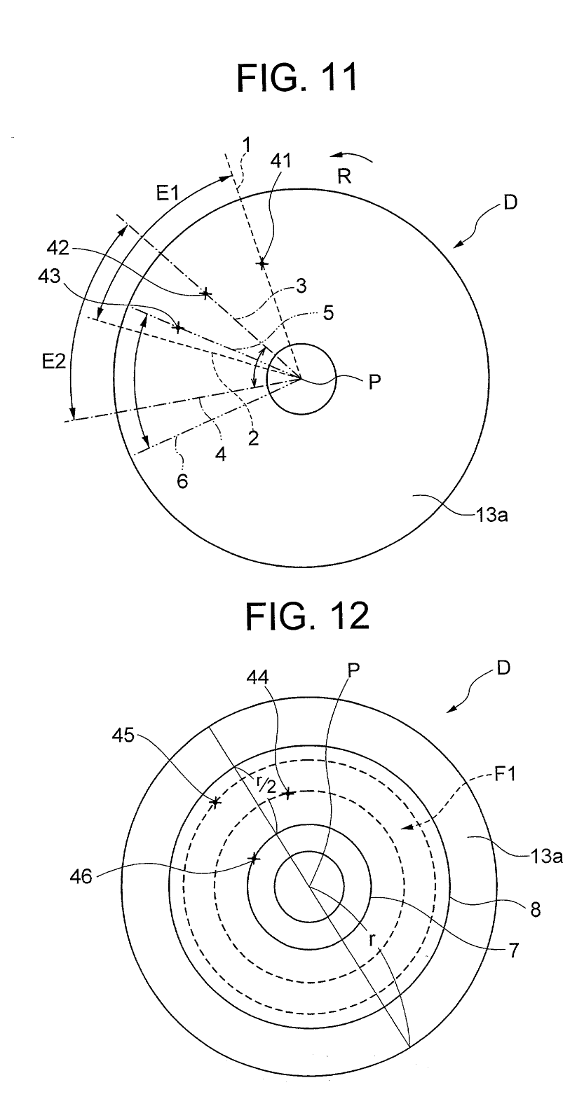

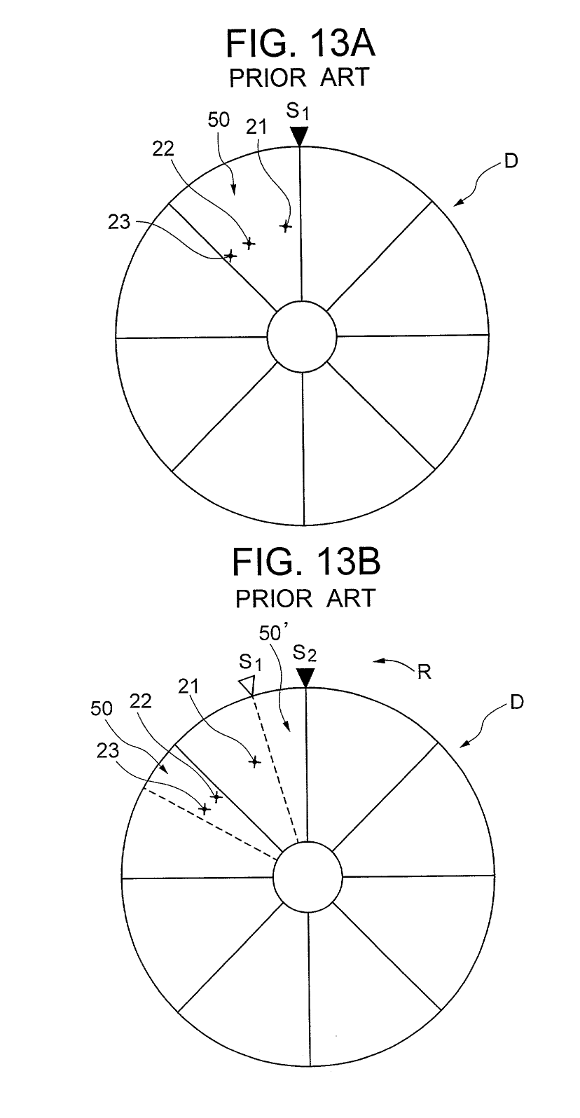

Next, a method of judging whether a plurality of defects are accepted or unaccepted in the second embodiment, will be explained referring to FIG. 11. The CPU 340 in the inspection apparatus in FIG. 8 judges whether the defects are accepted or unaccepted.

In accordance with the second embodiment, as shown in FIG. 11, a criterion for judging whether the disk member 13 is accepted or unaccepted is that if three or more defects exist in one of segments into which the surface of the disk member 13 is segmented at 45 degrees about a central point p in the circumferential direction, this disk member is judged to be defective. This is because if minute defects exist, only defect does not exert an averse influence, however, if these defects are aggregated, a trouble of the adverse influence that might arise is to be removed. In this case, as shown in FIG. 11, if defects 41, 42, 43 are detected on the inspection target surface of the surface 13a of the disk member 13, the positions of the defects 41 to 43 are pinpointed on the inspection target surface (13a) from the relationship between the scan count and the pixel No. of the pixels of the line camera 300.

A counter 341 of the CPU 340 counts the number of defects, and segment areas E1, E2, E3 are respectively set afresh by the area setting unit 342 with the defects 41, 42, 43 being origins.

To be more specific, the first segment area E1 is formed in a segmental shape defined by broken lines 1, 2 extending in the radial directions and by the central point p as shown in FIG. 11 in a 45-degree range in a scan direction R about the central point p with the defect 41 being an origin. The defect 41 is positioned on a broken line 1. Similarly, the second and third segment areas E2, E3 are formed in the segmental shapes defined by one-dotted chain lines 3, 4 extending in the radial directions and by the central point p, and by two-dotted chain lines 5, 6 extending in the radial directions and the central point p as shown in FIG. 11 in the 45-degree range in the scan direction R about the central point p with the defects 42, 43 being origins. The defect 42 is positions on the one-dotted chain line 3, while the defect 43 is positioned on the two-dotted chain line 5.

The area on the inspection target surface containing the plurality of defects is segmented in the way described above into the first through third segment areas with the defects 41 to 43 each serving as the origin. As shown in FIG. 11, it follows that the first segment area E1 contains the three defects 41 to 43, the second segment area E2 contains the two defects 42, 43, and the third segment area E3 contains one defect 43. Then, the first segment area E1 contains the three defects, and hence the CPU 340 judges that the disk member is defective. Note that the first through third segment areas E1 to E3 might have an overlapped area depending on the positions of the plurality of defects detected.

In the inspection apparatus in FIG. 8, the information on the defects 41 to 43 described above and the result of judgement about the defect, are displayed on the display device 350 and printed by the printer 370. Further, the judgement as to whether the disk member is accepted or unaccepted can be outputted to the sequencer 360. If judged to be defective, it is possible to execute the process of removing the unaccepted disk member out of the inspection process.

As discussed above, if the plurality of defects are detected on the inspection target surface, the whole area is segmented into the plurality of segment areas with the respective defects being the origins, and the judgement is made from one of these segment areas, i.e., the segment area containing the maximum number of defects. Therefore, the judgement is accurate, and the defective disk member can be surely eliminated, thereby enhancing he inspection accuracy.

Note that the whole area on the inspection target surface containing the plurality of defects is segmented at every 45 decrees, and the disk member is judged to be unaccepted if one segment area contains the three or more defects in FIG. 11. The mode of segmentation and the number of allowable defects may, however, be properly changed depending on a category of the inspection target. Further, the segment area is formed at every 45 degrees counterclockwise with the one defect being the origin in FIG. 11, however, this formation may proceed clockwise. Moreover, the threshold values a1, b1 in FIG. 9 may be changed corresponding to the necessity.

Next, a modified example of the embodiment discussed above will be explained referring to FIG. 12. FIG. 12 shows a case where the whole area on the inspection target surface is divided at a predetermined distance in the radial directions. When defects 44, 45, 46 are detected on the inspection target surface (13a) having a radius r on the disk member 13, the inspection target surface is divided so as to form respective areas defined by one circumference of which a radius is a distance from the central point p up to the position of the defect, and by a circumference spaced a distance of r/2 away from the defect (circumference) towards outside in the radial directions.

As shown in FIG. 12, there is formed a circumference 7 of which a radius extends from the central point p up to the position of the innermost peripheral sided defect 46. Further, thee is formed a circumference 8 spaced a distance of r/2 away from the circumference 7 outwards in the radial directions. Then, supposing that a doughnut-shaped area circumscribed by the circumferences 7, 8 is set as an area F1, the defects 44 to 47 exist in this area F1. In the case of this modified example, a criterion for judging whether the disk member 13 is defective or not is that if the three or more defects are contained in one circumferential area spaced the distance of r/2 in the radial directions on the disk member 13, this disk member is considered defective, and, based on this assumption, the area F1 contains the three defects 44 to 46, so that this disk member is judged to be unaccepted. Further, a similar doughnut-shaped area is formed with the defects 45 and 46 being the base points.

Note that when divided into the respective areas in the case of FIG. 12, for example, the distance from the circumference 7 to the circumference 8 may be set otherwise, and, when forming the circumference 8 spaced the distance r/2 from the circumference 7, the circumference 8 may be formed inwards in the radial directions.

It is also noted that the inspection apparatus in FIG. 8 detects the surface defects such as the pinhole, the damage, the wetting, the foreign matter etc, and is also capable of detecting the internal defects. If a plurality of these defects are detected, the judgement about the defects is made by the method described above.

The present invention has been discussed so far by way of the second embodiment but is not limited to this. The present invention can be modified in the variety of forms within the scope of the technical concept of the present invention. For instance, when determining the are with each defect being the start point, the inspection target surface may be divided in both in the circumferential direction and in the radial direction by using a combination of the method in FIG. 11 and the method in FIG. 12. Further, the light beams from the light source in FIG. 8 fall on the disk member, and the reflected light beams therefrom may be received by the line camera as the light receiving device, and the same effect as in the case of the transmitted light is obtained.

Moreover, the inspection target disk member is categorized as the optical disk that includes, specifically, the CD, the CD-R, the CD-RW, the MD, the DVD etc. The disk member may be the light transmissive substrate for those recording mediums but is not limited to this type of substrate. The disk member may be, as a matter of course, those for other applications.

Further, what is aimed at in the second embodiment is the defect of such a characteristic that if the defect solely exists on the disk member, this disk member is accepted, however, if the plurality of defects exist thereon, the disk member is defective. The judgement of how much the defects are critical is made by the method involving the criteria of the length and area size of the defect detected based on the difference between the received light quantities. The present invention is not, however, confined to this method.

According to the second embodiment, when detecting the plurality of defects on the disk member as the disk-shaped recording medium, it is feasible to make the precise judgement, increase the inspection accuracy, and enhance the quality of the disk member.

<Third Embodiment>

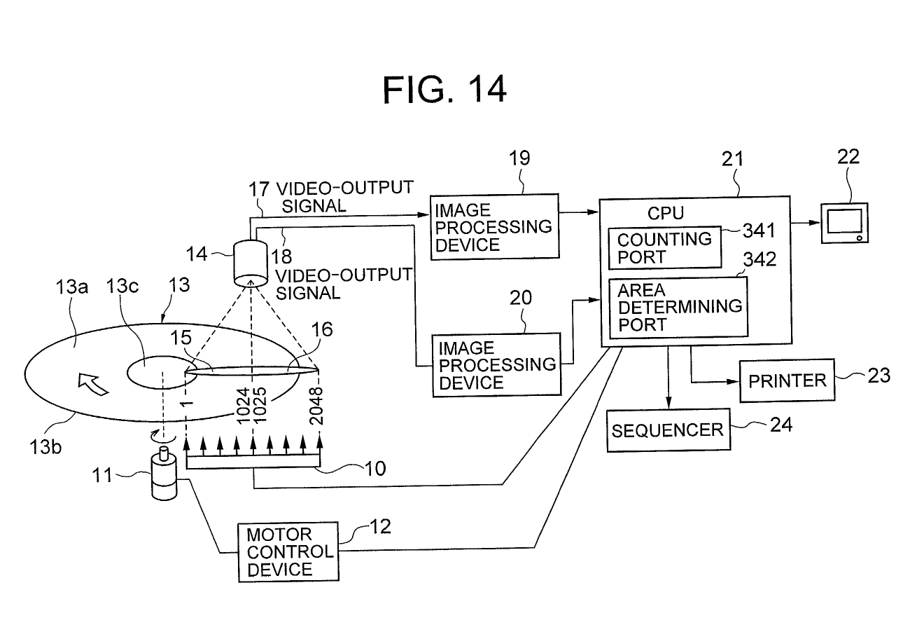

FIG. 14 is a diagram schematically showing an inspection apparatus for inspecting the disk member in a third embodiment. The inspection apparatus shown in FIG. 14 has a different construction that the CPU 21 in FIG. 1 includes a counter 341 for counting the number of defects when a plurality of defects are detected on the disk member 13 that is the same as shown in FIG. 8, and an area setting unit 342 for setting the area with each defect being the origin for every defect, and judges whether or not the defect in each area is critical or not. Other than these points, the inspection apparatus in FIG. 14 is substantially the same as the inspection apparatus shown in FIG. 1.

An operation of the inspection apparatus in FIG. 14 will be explained. In the same way as in FIG. 1, the multiplicity of pixels (of which the number is, e.g., 2048) are divided into two blocks on the inner and outer peripheral sides in the line direction. The imaging areas 15, 16 on the inspection target surface of the disk-shaped medium 13 divided corresponding to the two-divided blocks are scanned simultaneously, and the signals obtained are subjected to the image processing in parallel by the separate image processing devices 19, 20, thereby detecting the defects. Therefore, the inspection time can be reduced. In this case, if the defect signal is detected at the boundary between the divided blocks, as in the case of FIGS. 4A and 4B, the linking process is executed based on the scan count, and it can be judged whether or not the defect signals may be defined as the same continuous defect signal.

The inspection target surface on the disk-shaped medium 13 is divided and then inspected as described above. If the plurality of defects are detected on the one single disk member, the counter 341 of the CPU 21 counts the number of defects, and the area setting unit 342 sets the plurality of areas afresh with the defects being the start points as shown in FIG. 11 or 12. Then, in the same way as in FIGS. 8 through 12, it is judged based on the area containing the largest number of defects whether or not the defects are critical. It is therefore feasible to make the judgement accurate, certainly remove the defective disk member, and enhance the inspection accuracy.

According to the third embodiment, the inspection time can be reduced while keeping the inspection accuracy with respect to the disk member, and, when detecting the plurality of defects, it is possible to make the precise judgement about the plurality of defects and enhance the inspection accuracy.

What is claimed is:

1. An inspection method of inspecting a disk member, comprising:
a step of irradiating an inspection target surface of said disk member with light beam;
a step of receiving the light beam reflected from or penetrating the inspection target surface by light receiving means disposed towards an outer periphery from the center of said disk member;
a step of obtaining information by said light receiving means moving relatively to said disk member;
a step of inspecting said disk member on the basis of the information; and
a step of distinguishing between a normal spot and a defective spot,
wherein said light receiving means is divided into a plurality of blocks, and
respective informations obtained from said divided blocks are processed in parallel.

2. An inspection method according to claim 1, wherein said light receiving means is configured by an aggregation of a plurality of pixels arranged in lines,
said aggregation of the plurality of pixels is divided into two or more blocks, and
the normal spot is distinguished from the defective spot on the basis of the information subjected to a linking process after being obtained in parallel per block.

3. An inspection method according to claim 1, wherein when target signals are detected at a boundary between the proceeding block and the next block among the divided blocks, a linking process of linking these signals is executed.

4. An inspection method according to claim 1, wherein the light beam are visible light beam or near infrared-rays,
a difference between received light quantities of the reflected light beam or transmitted light beam in said light receiving means, is set as an individual information obtained from the divided block,
these informations are set as image information and processed in parallel by an image processing device and thereafter processed in linkage by a central processing unit, and
it is judged whether said disk member is accepted or unaccepted from a threshold value predetermined based on the above distinction, and a result of this judgement is displayed on said display device.

5. An inspection apparatus for inspecting a disk member, comprising:
a light source for irradiating an inspection target surface of said disk member with light beam;
light receiving means, for receiving the light beam reflected from or penetrating the inspection target surface, disposed towards an outer periphery from the center of said disk member;
moving means for moving said disk member relatively to said light receiving means; and
distinguishing means for inspecting said disk member on the basis of information obtained by said light receiving means moving relatively to said disk member, and distinguishing between a normal spot and a defective spot,
wherein said distinguishing means divides said light receiving means into a plurality of blocks, and processes respective informations obtained from said divided blocks in parallel.

6. An inspection apparatus according to claim 5, wherein said light receiving means is configured by an aggregation of a plurality of pixels arranged in lines,
said aggregation of the plurality of pixels is divided into two or more blocks, and
the normal spot is distinguished from the defective spot on the basis of the information subjected to a linking process after being obtained in parallel per block.

7. An inspection apparatus according to claim 5, wherein if target signals are detected at a boundary between the proceeding block and the next block among the divided blocks, a linking process of linking these signals is executed.

8. An inspection apparatus according to claim 5, wherein said distinguishing means includes an image processing device, a central processing unit and display device,
the light beam is visible light beam or near infrared-rays,
a difference between received light quantities of the reflected light beam or transmitted light beam in said light receiving means, is set as an individual information obtained from the divided block,
these informations are set as image information and processed in parallel by an image processing device and thereafter processed in linkage by said central processing unit, and
it is judged whether said disk member is accepted or unaccepted from a threshold value predetermined based on the above distinction, and a result of this judgement is displayed on said display device.

9. An inspection method of inspecting a disk member, comprising:
a step of irradiating an inspection target surface of said disk member with light beam;
a step of receiving the light beam reflected from or penetrating the inspection target surface by light receiving means disposed towards an outer periphery from the center of said disk member;
a step of obtaining information by said light receiving means moving relatively to said disk member;
a step of inspecting said disk member on the basis of the information; and
a step of distinguishing between a normal spot and a defective spot,
wherein when counting the number of defects existing in areas into which the inspection target surface is arbitrarily divided, the areas are set afresh with the defects being origins for every defect.

10. An inspection method according to claim 9, wherein the arbitrarily divided areas are segment areas into which the inspection target surf ace is segmented at a predetermined angle in the circumferential direction.

11. An inspection method according to claim 9, wherein the arbitrarily divided areas are areas into which the inspection target surface is divided at a predetermined distance in the radial direction.

12. An inspection method according to claim 9, wherein said light receiving means is configured by an aggregation of a plurality of pixels arranged in lines,
the light beam is visible light beam or near infrared-ray,
a normal spot and a defective spot are distinguished from each other based on a difference between received light quantities of the reflected light beam or transmitted light beam in said light receiving means, and
it is judged whether said disk member is accepted or unaccepted from a threshold value predetermined based on the above distinction.

13. An inspection apparatus for inspecting a disk member, comprising:
a light source for irradiating an inspection target surface of said disk member with light beam;
light receiving means, for receiving the light beam reflected from or penetrating the inspection target surf ace, disposed towards an outer periphery from the center of said disk member;
moving means for moving said disk member relatively to said light receiving means;
distinguishing means for inspecting said disk member on the basis of information obtained by said light receiving means moving relatively to said disk member, and distinguishing between a normal spot and a defective spot;
count means for counting the number of defects existing in areas into which the inspection target surface is arbitrarily divided; and
setting means for setting the areas afresh with the defects being origins for every defect.

14. An inspection apparatus according to claim 13, wherein the arbitrarily divided areas are segment areas into which the inspection target surface is segmented at a predetermined angle in the circumferential direction.

15. An inspection apparatus according to claim 13, wherein the arbitrarily divided areas are areas into which the inspection target surface is divided at a predetermined distance in the radial direction.

16. An inspection apparatus according to claim 13, wherein said light receiving means is configured by an aggregation of a plurality of pixels arranged in lines,
the light beam is visible light beam or near infrared-ray,
a normal spot and a defective spot are distinguished from each other based on a difference between received light quantities of the reflected light beam or transmitted light beam in said light receiving means, and
it is judged whether said disk member is accepted or unaccepted from a threshold value predetermined based on the above distinction.

17. An inspection apparatus for inspecting a disk member, comprising:
a light source for irradiating an inspection target surface of said disk member with light beam;
light receiving means, for receiving the light beam reflected from or penetrating the inspection target surface, disposed towards an outer periphery from the center of said disk member;
moving means for moving said disk member relatively to said light receiving means;
distinguishing means for inspecting said disk member on the basis of information obtained by said light receiving means moving relatively to said disk member, and distinguishing between a normal spot and a defective spot, said distinguishing means dividing said light receiving means into a plurality of blocks and processing in parallel pieces of information obtained from the divided blocks;
count means for counting the number of defects existing in areas into which the inspection target surface is arbitrarily divided; and
setting means for setting the areas afresh with the defects being origins for every defect.

18. An inspection method of inspecting a disk member, comprising:
a step of irradiating an inspection target surface of said disk member with light beam;
a step of receiving the light beam reflected from or penetrating the inspection target surface by light receiving means disposed towards an outer periphery from the center of said disk member;
a step of obtaining information by said light receiving means moving relatively to said disk member;
a step of dividing said light receiving means into a plurality of blocks, processing in parallel respective pieces of information obtained from the divided blocks, and linking these pieces of information between the divided blocks;
a step of distinguishing between a normal spot and a defective spot on the basis of the pieces of information linked;
a step of arbitrarily dividing the inspection target surface on said disk member;
a step of counting the number of defects existing in areas into which the inspection target surface is arbitrarily divided;
a step of setting the areas afresh with the defects being origins for every defect; and
a step of judging whether or not the defects are critical in the areas set afresh.
